(19) United States
(12) Patent Application Publication
(10) Pub. No.: US 2020/0320432 A1
(43) Pub. Date: Oct. 8, 2020

(54) FAST ARTIFICIAL INTELLIGENCE OPERATIONAL SYSTEM

(71) Applicant: AMARIS.AI PTE. LTD., Singapore (SG)

(72) Inventors: Khue Hiang CHAN, Singapore (SG); Chien Siang YU, Singapore (SG)

(21) Appl. No.: 16/798,410

(22) Filed: Feb. 23, 2020

Related U.S. Application Data
(60) Provisional application No. 62/808,852, filed on Feb. 22, 2019.

(51) Int. Cl. G06N 20/00; G05B 17/02; G05D 23/19

(52) U.S. Cl. CPC G06N 20/00; G05D 23/1917; G05B 17/02

(57) ABSTRACT

A bio-inspired artificial intelligence operational system (AIOps) and method are disclosed. The AIOps system includes an AI module with low-level containers configured to gather, identify extract, translate and transform incoming data, a redesigner module with high-level containers configured to enrich the low-level data from the AI module data with knowledge integration from past transactions to deliver an AI output in the form of, for example, a recommendation, a prediction, an abnormality detection, and event categorization, and a temperature module with temperature containers configured to efficiently detect and handle outages and component faults of the AI and redesigner modules. The AIOp system can be employed to generate a high performance and reliable Fast Data system.

### CROSS-REFERENCE TO RELATED APPLICATION

This application claims the benefit of U.S. Provisional Application No. 62/808,852, filed on Feb. 22, 2019, which is incorporated herein by reference in its entirety for all purposes.

### FIELD OF THE INVENTION

The present disclosure relates to artificial intelligence operational (AIOp) systems. In particular, the present disclosure relates to bio-inspired AIOp systems which can rapidly redevelop, tune and optimize real-time big data streaming systems for enterprises.

### BACKGROUND

With the plethora of new technologies being implemented, such as 5G, software-defined networks (SDNs) as well as new Fintech technologies which exploit sharing economy, many companies, especially telecommunication companies and financial institutions, such as banks, are faced with technology disruptions. In addition, companies must comply with the growing set of regulatory requirements, such as cybersecurity, resiliency and data privacy, imposed by governmental agencies. Due to the ever increasingly complex and dynamic world resulting from economic globalization, data has become a critical part of any successful corporate strategy. For example, companies have considered data as the new oil.

Companies, particularly data-heavy companies, must continuously keep up to date with their Big Data systems to continuously improve productivity. Conventional implementations of Big Data systems using traditional information technology (IT) is ineffective. For example, traditional IT, with its waterfall systems lifecycle development, is highly static and would require human attention for tuning and maintenance. Such legacy systems which were initially constructed on an ad-hoc basis using outdated technologies, such as data warehouses, relational databases, or inherently slow Hadoop big data stores, are ineffective to meet the demands of real-time data processing of a massive volume of transactions and streamlining telemetry.

Other implementations of Big Data systems may include an artificial intelligence (AI) strategy. These implementations may include step by step robotic process automation (RPA) or combining multiple disparate silo artificial intelligence products. However, both these AI implementations are ineffective. For example, RPA, although automated, is a long and tedious step-by-step process. As for systems with disparate AI silo systems, each AI silo subsystem requires separate management and installation processes, security and privacy protection as well as staff training. Both RPA and silo approaches require significant manpower, requiring significant costs and long deployment time. Furthermore, both RPA and the silo approach will be met with complex integration challenges, especially when an enterprise takes on more and more AI capabilities.

From the foregoing discussion, there is a need to automate the intersection of efficient Big Data streaming and AI to provide agencies and data-heavy enterprises with expertise-lean and manpower-light Big Data solutions that are self-guiding and highly automated at build-time, while always highly adaptive to changing business conditions.

### SUMMARY

Embodiments generally relate to artificial intelligence operational (AIOp) systems. In particular, the present disclosure relates to bio-inspired AIOp systems which can rapidly redevelop, tune and optimize real-time big data streaming systems for enterprises.

In one embodiment, an artificial intelligence operational system including an AI module includes low-level containers configured to gather, identify extract, translate and transform incoming data, a redesigner module with high-level containers configured to enrich low-level data from the AI module with knowledge integration from past transactions to deliver an AI output as well as a temperature module with temperature containers for detecting and handling outages and container faults in the AI and redesigner modules.

These and other advantages and features of the embodiments herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of various embodiments. In the following description, various embodiments of the present disclosure are described with reference to the following, in which:

FIG. 1 shows an environment of a simplified exemplary embodiment of a Fast AIOp system;

FIG. 2 illustrates an exemplary flow for monitoring, load adjustment, and self-healing by the AIOp system;

FIG. 3 shows an exemplary embodiment of a flow for mapping policy documents into a strategy by the AIOp system;

FIG. 4 illustrates an exemplary flow as to how external world feeds influence AI decision-making of the AIOp system;

FIG. 5 shows an exemplary embodiment of a toolbox of the AIOp system;

FIGS. 6a-b illustrate various exemplary self-generating AI containers to improve performance of AIOp system;

FIG. 7 illustrates a chart depicting how the AIOp system evolves over time; and

FIG. 8 illustrates an exemplary maturity model generated by the AIOp system.

### DETAILED DESCRIPTION

Embodiments described herein generally relate to a real-time Big Data system. In particular, embodiments relate to a fast artificial intelligence operational (AIOp) system. The fast AIOp system employs software that memory caches streaming data, predictively fetches required data and dynamically generates new retrieval indexes for real-time reporting applications. Such fast AIOp systems, for example, are particularly useful for heavy data enterprises, such as telecommunications or ePayment/Fintech companies, servicing typically millions of customers.

The AIOp system is configured to comprehensively address integrative aspects of RPA and silo AI by coordinating and sharing AI operations across multiple business units. Furthermore, IT infrastructure investments are streamlined for solving issues due to complex legacy systems that are unable to evolve to handle Big Data AI Operation requirements. The AIOp system enables automation of the intersection of efficient Big Data streaming and AI to provide agencies and data-heavy enterprises with expertise-lean and manpower-light Big Data solutions. The AIOp system is self-guiding and highly automated at build-time and is highly adaptive to changing business conditions. In addition, the AIOp system enables operational cost savings by using both software and hardware components.

In one embodiment, the AIOp system has the ability to rapidly redevelop, tune and optimize a real-time big data streaming system. Furthermore, the AIOP system is capable of automatically generating a fast data flow design. The ATOP system is bio-inspired, utilizing concepts parallel to how a human body works to regulate our energy intake for locomotion and other biological functions. In particular, the AIOP system is structured to include various subsystems which map to 1) a respiratory lung system, 2) a blood flow system that delivers oxygen from the lungs to the rest of the body, and 3) a body temperature regulatory system that serves as feedback between the external world and how the internal body parts are coping with their respective functional demands. As such, by exploiting a style that mimics nature for constant temperature regulation, the AIOP system can be adaptive and responsive to numerous environmental variations and changing demands by leveraging these self-organized human systems, working elegantly with each other. For example, if the room temperature is freezing, the body takes in more air and to shiver as well as to pump more blood to generate heat. The human body can also dynamically adjust to different situations or environments.

The subsystems of the AIOp system, for example, may include an Air Fast (A-Fast) module, a blood fast (B-Fast) module and a temperature fast (T-Fast) module. The A-Fast module is configured to be a rapid real-time data ingestion subsystem. For example, the A-Fast module is a Big Data subsystem that supports fast embedded machine learning (ML) processing or algorithms. For example, the A-Fast module includes ML units for ML processing functions. Machine learning processing is advantageous for expeditiously processing large amounts of data. The A-Fast module includes a cache for processing data as it flows into the system. The cache enables the system to process data in pulse cycles, similar to the lung system which is capable of holding air in breathing cycles. The ML units are an integral part of the data flow engines. For example, the ML units are configured to extract feature data from incoming data and pass the feature data to the B-Fast module, similar to extracting oxygen from the air and passing it into the bloodstream.

The B-Fast module is configured to exploit and feed the lower-level data into multiple higher-level software containers of AI executables for running decision making, knowledge sensing, dataset transformation, and discovery collation sub-systems. These various containers are networked to the control T-Fast module for regulating the rate of execution, such as by monitoring energy consumption. The T-Fast module is configured to maintain a steady pace to ensure system performance.

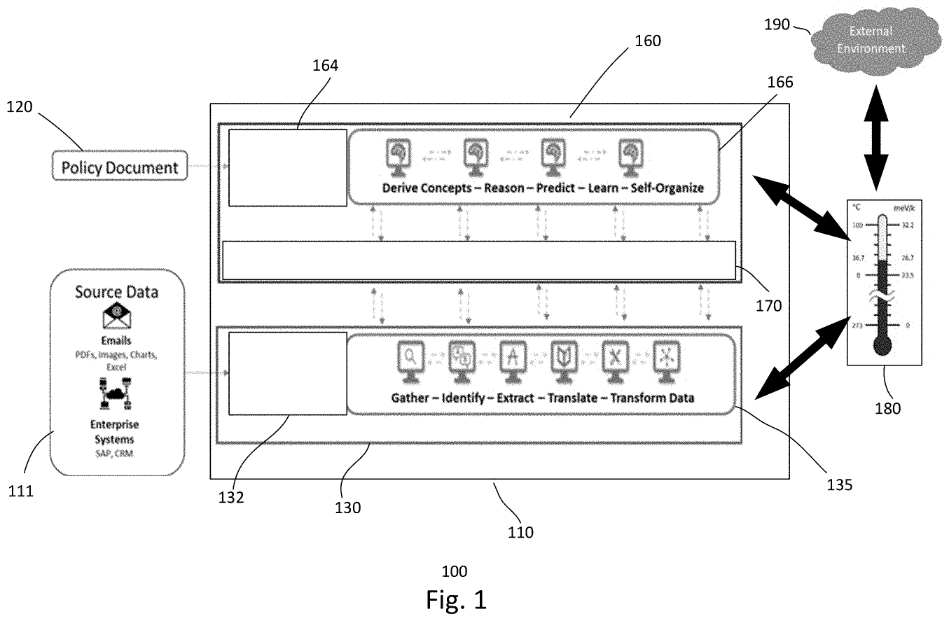

FIG. 1 shows an environment 100 of a simplified embodiment of a Fast AIOp system architecture or platform 110. As shown, the system includes an AI module 130, a REDESIGNER (redesigner) module 160, and a temperature module 180. As discussed, the system is a bio-inspired system. For example, the AI module may be the A-Fast module (analogous to the respiratory lung system), the redesigner module may be the B-Fast module (analogous to a blood flow system), and the temperature module may be the T-Fast module (analogous to the body temperature regulatory system).

The AI module is configured to be a rapid real-time data ingestion subsystem. For example, the AI module is configured to process incoming source data 111. The source data, for example, may include emails, PDFs, images, charts and excel files as well as data from enterprise systems, such as SAP, CRM, and others.

In one embodiment, the AI module includes an AI subsystem unit 132 with an AI module container subunit 135. The AI container subunit includes a plurality of AI module software containers 135. The AI module containers, for example, are Docker containers. Other types of containers may also be useful. The AI module containers employ machine learning (ML) processing or algorithms. In one embodiment, the AI module containers are low-level containers that interface with data action modules of the source data, resembling, for example, human senses for feeling, touching, hearing, reading and listening. For example, the AI module containers are employed for performing different functions. The AI module containers may be configured to gather, identify extract, translate and transform the data for processing by the redesigner module 160.

The redesigner module 160 is configured to process the data processed by the AI module. In one embodiment, the redesigner module includes an AI cognition unit 164 with an AI cognition container subunit 166. In addition, the redesigner module includes an in-memory module 170. The in-memory module, for example, serves as a cache for incoming data for processing by the AI module 130. In addition, the data processed by the AI module (low-level data) is processed by the AI cognition module via the in-memory module. For example, low-level data is passed to the in-memory module by the AI module for processing by the AI cognition unit.

The AI cognition container subunit 166 includes high-level software AI cognition containers. The AI cognition containers, for example, may be Docker containers. Other types of containers may also be useful. The AI cognition containers are configured to enrich the low-level data with knowledge integration from past transactions to deliver an AI output in the form of, for example, a recommendation, a prediction, an abnormality detection, and event categorization. In one embodiment, the AI cognition containers are configured to conceptualize, rationalize, predict, learn, memorize, and self-optimize the low-level data to gain cognitive problem-solving AI awareness.

AI awareness enables the system to direct its output system activities to achieve overall system optimization targets. The targets here are defined by a human-generated text-based document, such as a policy document 120. The policy document is provided to the redesigner module. The policy document may be provided as input to the cognition unit via the in-memory module. More than one policy document may be provided to the cognition module. The term document may be used to refer to a single document or to multiple documents.

The policy document, for example, may describe the Enterprise System Data Operations Policy. Performance objectives, monitoring and regulatory policies, along with new problem-solving targets and opportunities may be derived from the policy documents. In one embodiment, processing of the policy documents may be achieved using AI Natural Language Processing (NLP).

As for the temperature module 180, it includes an AI monitoring unit with AI monitoring containers, such as Docker containers. The AI monitoring containers are configured to monitor the AI and redesigner modules for regulatory and exception with outage handling according to the maintenance target defined at the initialization of the system. Additionally, the knowledge and understanding that the temperature module acquires from outside inputs 190 serve as guidance to continuously tune different modules to achieve greater levels of efficiency and optimization. For example, the temperature module may track new task assemblies/workflows for resource and energy efficiency gains or an expressed urgency to gain insights via reporting/visualization.

The temperature module also is configured to adjust the operations of the AI and AI and redesigner modules based on load demands and to instruct on how to handle outages automatically. This can be achieved through the scaling up of additional or new software containers. For example, the temperature module may load and activate the necessary containers as well as performing “self-healing” by eliminating containers that are faulty or have been cyber-attacked. As such, the AIOp system exhibits self-defending capabilities, analogous to those found in biological immune systems.

As described, the AIOp system utilizes a 2-level AI container configuration. The low-level containers of the AI module interfaces with the data sources for incoming data and passes it to the high-level containers of the redesigner module for processing. For example, the AIOp system exploits multiple software containers of AI executables as functional data sensing, data transformation, data stream processing and discovery collation modules to benchmark and assess a non-optimized Big Data infrastructure at a site.

The AIOp system may be utilized to understand the nature of Big Data flow and its choke points, the context of poor performance due to its storage systems, the weakness in the performance of Big Data processing nodes, types of data elements, and how the data should be optimally clustered and their respective fast retrieval requirements. With these inputs, the enterprise system can be repackaged for the best set of data pipelines to drive a significantly improved and integrated Big Data enterprise system for diverse real-time applications.

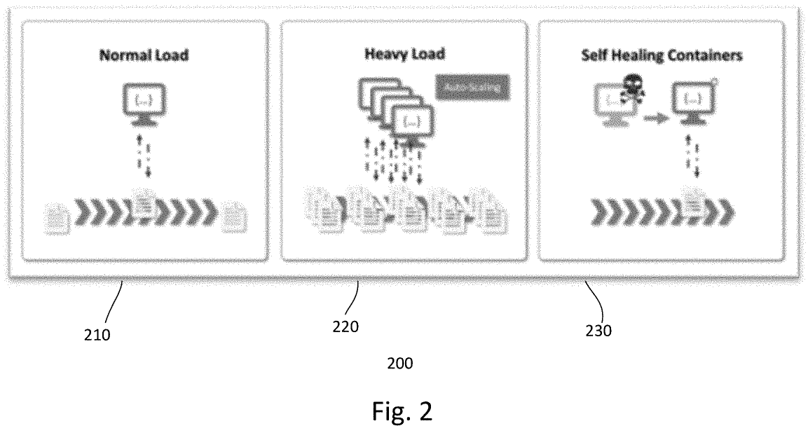

FIG. 2 illustrates a flow 200 for monitoring, load adjustment, and self-healing by the AIOp system. Flow 210 illustrates the temperature module monitoring the load of the AIOp system. For example, the temperature module monitors the AI module and redesigner module. As shown, the temperature module determines that the load is normal and there is no need to make any load adjustments.

In flow 220, the temperature module detects that the load on the modules is heavy and performance is negatively affected. The temperature module identifies containers required to handle the additional load detected and performs autoscaling of those containers needed. By autoscaling the needed containers, the performance of the AIOp system is normalized.

As for flow 230, the temperature module detects that a container is affected, such as by a container fault or by a cyber attack. The monitoring model deletes the affected container and replaces it with a non-affected one.

The present AIOp system is a bio-inspired Fast Data system which is configured to streamline the design and maintenance of Big Data systems. The AIOp is capable of automating a redesign of existing legacy data systems as well as fostering continuous efficiency by automating prototyping and testing of new data pipelining structures by having a tight collaboration between human stakeholders, designers and infrastructure operations teams with its AI decision making.

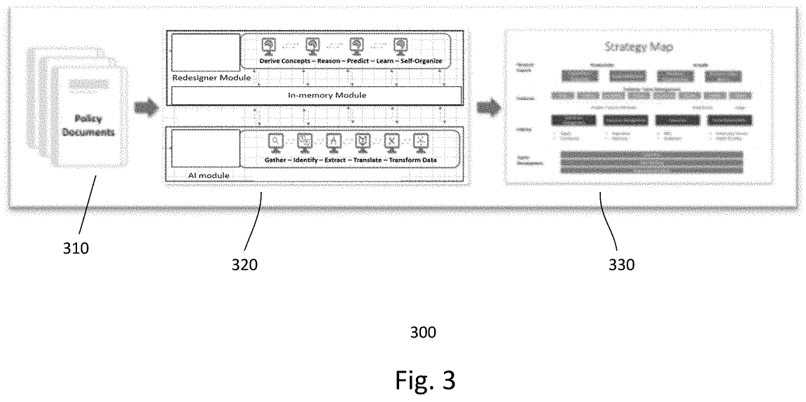

FIG. 3 illustrates an embodiment of a flow 300 for mapping policy documents into a strategy by the AIOp system. As shown, the AIOp system 320 is similar to the AIOp system in FIG. 1. As such, similar elements may not be described or described in detail. Furthermore, the AIOp system is simplified by not including the temperature module. However, it is understood that the simplified diagram of the AIOp system may include a temperature module.

Policy documents 310 are provided as input to the AIOp system. The policy documents may be related to human policy. The AIOp system extracts, tracks, and granularly maps text written policy documentation such as data flow charts, database schemas and field names, into a problem-solving implementation strategy 330. This problem-solving strategy makes use of a network of software containers, each individually performing specialized actions, albeit expressed via three modules. For example, the containers are from the AI module, AI cognition module and the temperature module. Furthermore, the network of containers from the AI and redesigner modules collaborate within a level (intra-level collaboration) or hierarchically (inter-level collaboration).

The containers may be a form of operating system virtualization. For example, For example, a single container might be used to run anything from a small AI microservice or software process to a larger application. Inside a container are all the necessary executables, binary codes, libraries, and configuration files. Compared to server or machine virtualization approaches, containers, such as Docker, do not contain operating system images. This makes them lightweight and portable, with significantly less overhead. In larger application deployments, multiple containers may be deployed as one or more container clusters. Such clusters might be managed by a container orchestrator, such as Kubernetes, and augmented by management from the AIOps system.

Initially, the AIOp system works with a human designer, for example via a visual data and/or workflow interface, to validate that its understanding of the input documents is correct. For example, the redesigner module works with the human designer. To facilitate faster problem solving, the system references well-known solutions, reusable modules, and practices for its initial iteration. It also proposes dashboards to track the streaming data and finalized reporting at the last stages.

In one embodiment, constructing the implementation strategy may include multiple stages. In one embodiment, the redesigner module uses data rates of endpoints which may be expressed within the policy target to derive the lowest input rates for the AI cognition module. By working backward, the system is able to derive the input data flow rates needed to generate the lower-level AI module containers' output rates. For example, the output rates of the machine learning containers of the AI module are derived. The redesigner then sizes the various containers of the AI module and determines if there are bottlenecks at the various stages. Inadequate data retrieval performance is corrected by using memory caching techniques. If the data stream is unable to flow fast enough, the system will identify the fastest possible data flow rate and highlight that it is not possible to meet the policy target.

As this initial iteration involves the assembly of multiple AI sections with varying degrees of accuracies, the system can compute the chain effect of AI processing and the final accuracy attainable. This is checked against the policy target, as the accuracy target may fail. There may be a case that the output may have different accuracies for different circumstances. In such a case, the user can state the lowest threshold required, and how to handle a prediction that is evidently not accurate enough. It is possible that the redesigner module may fail to find a solution that can satisfy the policy target. In such a case, the system examines hardware upgrading options, such as memory or CPU upgrades, cloud migration, or cost increases for better software. For software upgrades, the system defaults to using open source software solutions.

The system may attempt additional iterations to optimize the AI processing workflow by suggesting AI model optimization. For example, the system may suggest using improved algorithms to improve performance using AutoML (using AI to improve AI) or to use faster AI hardware accelerators.

To increase the success rate of improving performance, the use case should involve a template solution and a well-researched strategy. As an example, in order to detect fake credit cards, procurement fraud, or other types of issues, the key design parameters should be the top rate of credit card transactions, allowable AI inference time, and the accuracy required. With these input parameters, the system checks to determine if the infrastructure can manage the data flow and push it to offer the best possible accuracy to achieve the lowest possible number of false positives.

The AIOp system is capable of supporting many Big Data applications simultaneously. For instance, the same data flow for detecting fake credit cards can also be applied to other applications, such as to detect organized crimes using fake companies, to predict which customer may be the next to churn customers, as well as other types of applications.

To package the AIOp system for universal applications using the same data flow, a second stage iteration may be employed. The second stage is configured to utilize linear or constraint programming techniques if the combined addition of the various pipeline sections is not successful. Additionally, generative methods, such as genetic coding, optimized testing and failure elimination, and finally when necessary, generative adversarial networks (GANs), may be used to curate a new and unique solution.

In addition, to continuously improve itself, the system may employ reinforcement learning to track the system performance as well as the efficacy of the current AI strategy. This will result in a self-tuning, policy-driven AI problem-solving system that is user-friendly and easy to implement.

In one embodiment, the redesigner is configured to simplify the management of massive amounts of data, such as thousands of data streams, millions of messages, transactions and files, including multimedia data, by streaming data into a data lake. This will allow all enterprise applications to collate the amassed Big Data from the data lake and to automatically associate the data dictionary context for satisfying retrieval and reporting requirements in real-time. Furthermore, AI monitoring for data context switching improves the ability of the real-time presentation/reporting applications to eloquently handle situations where the executive user interjects a topic aside or changes the topic in the middle of the current dashboard context. The data lake enables a fast response to a fresh query.

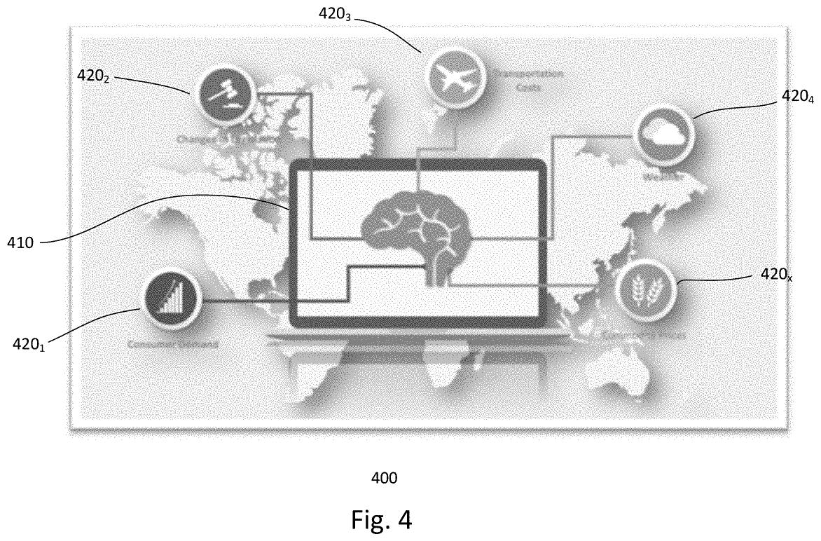

FIG. 4 illustrates a flow 400 as to how external world feeds influence AI decision. Business operations and decisions are influenced by external factors, such as implications of production demand/supply due to weather, seasonal reasons like Christmas shopping, or new economic policies. In one embodiment, the temperature module is configured to ingest external changes and inputs that will affect the required data flow rate and to convert them to impact the temperature module's temperature value, which will indirectly push the lower-level container to speed up or relax accordingly.

As shown, the temperature module 410 is configured to have the awareness and ability to track external changes as well as to consider the impact of these external factors to improve on the human-written text policy. In one embodiment, the temperature module achieves this objective by examining various external inputs 420₁₋ₓ, such as complaints, feedback from surveys, customer churn due to new competition, natural disasters, interest rates, news events, market trends and consumer demands, and other external inputs. The external input compiles these external inputs as an economic model. Thereafter, the temperature module utilizes AI prediction to incrementally adjust the input variables and/or workflow in order to achieve the optimized operational levels.

The system's contextual awareness enables an enterprise to automate its low-level AI control facilities within the temperature module, allowing the original set of defined targets to be incrementally adjusted as the environment changes.

The system may be configured to provide human decision support. For example, the AIOp system generates advisories for any missing information, gaps discovered as well as analysis of problems and issues. The system may also be configured to depict the corrective actions needed. This facilitates human decision making on a full range of issues, ranging from functional tuning to sophisticated strategy relook. Furthermore, the temperature module can present its temperature value, which is regulated and serves as a warning would be apparent if the system develops a fever (high internal system temperature). This will signal that external intervention would be needed, analogous to calling a doctor.

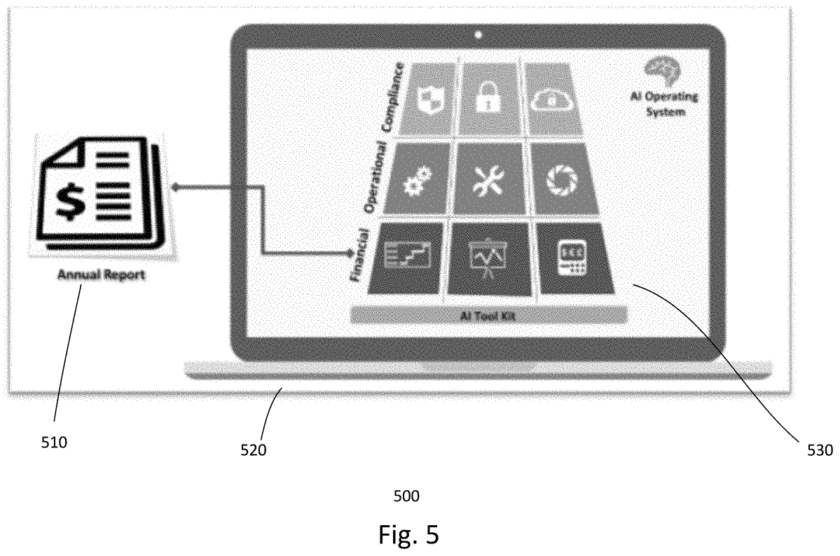

In one embodiment, the AIOp system adopts a large AI tool-box approach that will leverage off the efficient use of modular containers. FIG. 5 shows an embodiment of a toolbox 500 of the AIOp system. As shown, the AIOp system runs on a computing device 520. The computing device includes a processor and memory. The computing device, for example, may be a general purpose computer, including a desktop computer, laptop computer, or a tablet computer. Other types of computing devices may also be useful.

The AIOp system includes a user interface (UI) which is displayed on a display of the computing device. The UI enables a user to navigate the AIOp system. In one embodiment, the UI includes a toolbox page 530. The toolbox page includes a plurality of containers available in the system. The different containers, for example, are Docker containers. Other types of containers may also be useful. Different containers are configured to perform different functions. The containers may be grouped by categories according to the functions, such as financial, operational and compliance. Other categories may also be included.

These containers can be combined in a multitude of ways to suit various needs and requirements. For example, using a mouse or other types of input devices, a user may select one or more containers to perform the desired functions. As shown, financial containers may be selected to generate an annual report 510. The toolbox of containers enables the AIOp system to be dynamic. For example, a user can select the right containers from the toolbox according to the job or task. The multi-tool approach may utilize a memory cache with inter-container communications to support tight integration.

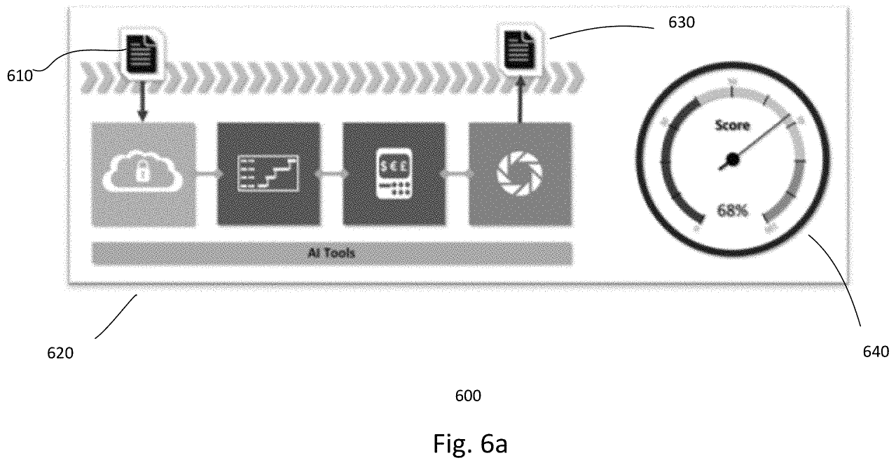

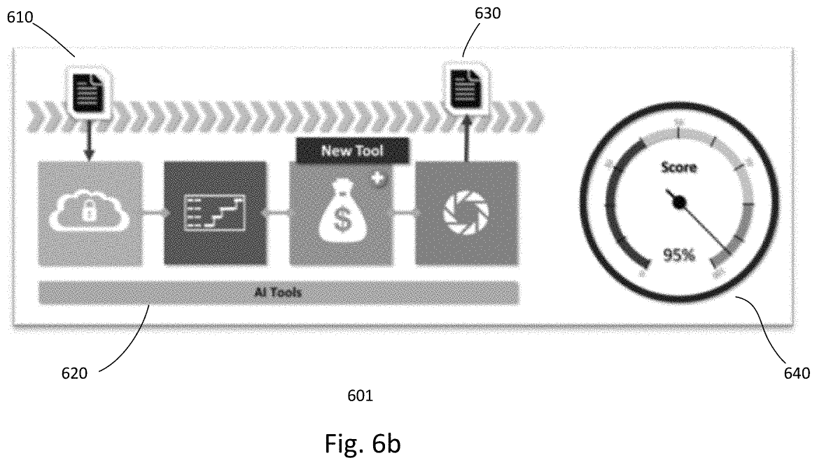

The AIOp system may be further configured with the ability to self-create specialized containers, new network paths, new data output workflows or develop new AI learning. FIG. 6a illustrates a scenario 600 in which the set of existing containers or tools 620, including a combination thereof, is inadequate for a job. As shown, based on the input requirements 610, the system generates an output 630. However, as shown by the score 640, the performance is inadequate.

In such cases, the system will signal the need for new problem-solving capabilities. FIG. 6b illustrates a scenario 601 in which the AIOp system self-creates a new container for the tool set 620 in response to a signal that the current set of containers is inadequate to achieve the target. As shown, the new container enables the AIOp system to perform the job 630 based on the input requirements 610 adequately, as shown by the score 640.

The AIOp system, as described, includes a toolbox with a set of containers as well as the ability to self-create new tools to perform the necessary job with the target performance. This gives the user flexibility in selecting the right container or containers to perform the job adequately. In the event that the set of existing containers is incapable of adequately performing the job, the AIOp system creates new containers necessary to perform the job adequately. This is analogous to how a human artisan can use different specialised tools with great dexterity. The tool user would know which tools would work best for each given situation and why it is optimal to allocate a distributed usage at different stages and time. If the existing set of tools is inadequate, the artisan is able to imagine a new kind of tool should be developed and will then proceed to design, test and create it.

The AIOp system has the capability to self-improve to evolve. For example, the AIOp system may orchestrate further structural specialisations to evolve and adapt the corporate IT system against negative trends, adversarial or sudden local changes. The ability to self-improve and evolve is facilitated by a reflex AI, an affective AI, and a learning AI. The ability to self-improve and evolve results in continuously improving the AIOp's ability to develop an efficient Big Data AIOp system.

The reflex AI enables the AIOp system to discover events that will require simple but extremely fast reactions. The affective AI is employed by the AIOp system to comprehend human emotions. By understanding human motivation and psychology, the system will be able to avoid misunderstandings and address human needs, leading to superior outcomes. As for the learning AI, it imparts to the system the ability to learn from past events. The system identifies and collates lessons learned as powerful narratives for future strategies and to grow its knowledge base for understanding humans. For example, lessons learned serve as reinforcement learning for a product review feedback loop. The AI counts the failures and evolves new strategies by using a combination of generative adversarial networks (GANs).

The system may refine its Big Data know-how and intuition by leveraging off its AI data ingestion service to measure how well and effective the difficult and time-consuming tasks of building, running, and managing data pipelines have been understood and managed by users. The AIOps system may also track user actions, such as drag-and-drop of various sources, data transforms, analytics, syncs as well as other actions, through an interactive studio interface. This allows the system to interact with and assist users. For example, the system can highlight past practices that were highly effective, suggest template designs, and provide simulation data to show which are the best design choices.

High-level abstractions and deep integrations with diverse Big Data technologies could be introduced to users in an easy to understand and meaningful way. In addition, the system can tutor the human designer on how to dramatically increase productivity and quality, concurrently speeding up development and reducing time-to-production. This expedites delivery of the various Big Data projects.

Furthermore, the standardization of data in varied storage engines and data that is computed on varied processing engines promotes reusability. This will simplify security, operations and governance across projects and environments.

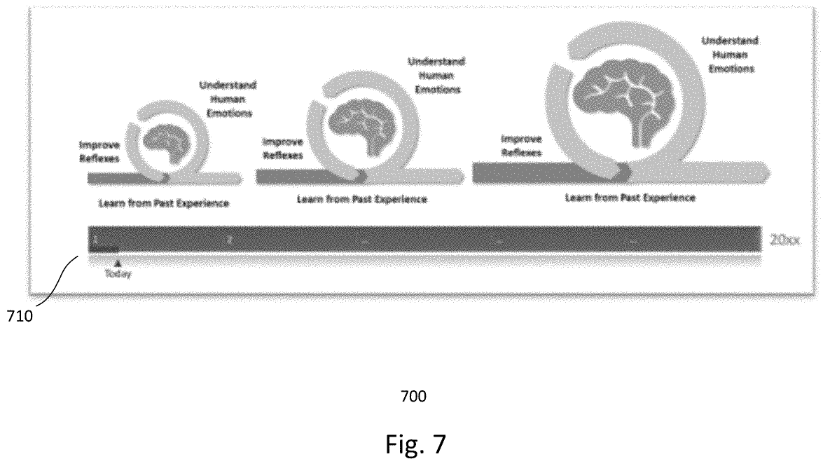

FIG. 7 shows a chart 700 illustrating how the AIOp system evolves over time. A timeline 710 illustrating the AIOp system's knowledge is depicted. Over time, the AIOp system continues to grow as it continues to learn, as depicted by the larger size of the AIOp system. For example, the AIOp system's reflexes, understanding of human emotions and big data intuition continues to improve as more lessons are learned due to a greater amount of experience. Given time in an organization, the system will be able to develop a set of fast responses as well as user-friendly interactions that are “curated” for the specific organization.

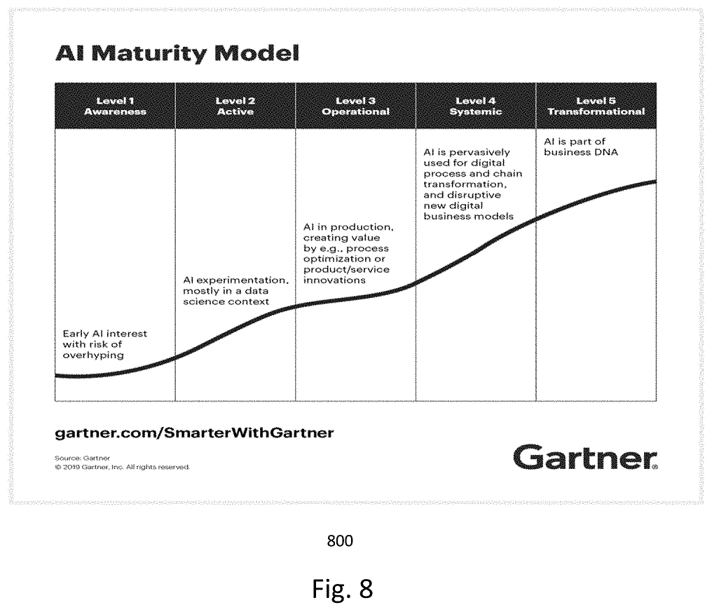

FIG. 8 illustrates an example of a maturity model 800 generated by the AIOp system. The AIOps system includes an in-built AI enterprise maturity model generator. Inputs to the AIOp system are used to recommend how an enterprise can start its Big Data operations and start growing with a small initial investment, supporting an easy and risk-reduced start (level 1). The level 1 getting started model is instrumental in supporting a full-fledged AI First corporation (level 5) via its advanced and dynamic AI operating structure using software containers and modernized software, such as by exploiting Big Data in a public cloud instead of a private cloud, by replacing its legacy datamart and relational databases with Big Data storage like Hadoop storage, by transforming data reporting and analytics into automated business robotic interventions, as well as other advances.

The AIOp system, using AI techniques, predicts various new possible outcomes, computes the cost and risk of change, as well as the improvements that will accrue. These will be presented for executive review, highlighting how a step by step series of upgrades will lead to a remediation of the performance bottlenecks that are currently hindering efficient operations, and C Suite visibility of the market conditions.

In addition, this will allow new future AI operational concepts to be incrementally tested, simulated and exploited, bringing in savings and gains quickly which will fund subsequent expansion via new projects. The AIOp system also allows existing staff to learn and to adapt to the new workflows and business models, facilitating customer and partner adaption as well.

Significant technological AI improvements can be anticipated from the stage-by-stage implementation of AI. The resulting AIOps system enables an enterprise to easily meet requirements that may be demanded by future regulatory compliance as well as for demonstrating strong countermeasures against AI Adversarial Attacks despite AI processing within black-boxes for explainable and trustworthy AI.

The inventive concept of the present disclosure may be embodied in other specific forms without departing from the spirit or essential characteristics thereof. The foregoing embodiments, therefore, are to be considered in all respects illustrative rather than limiting the invention described herein. The scope of the invention is thus indicated by the appended claims, rather than by the foregoing description, and all changes that come within the meaning and range of equivalency of the claims are intended to be embraced therein.

What is claimed is:

1. An artificial intelligence operational system comprising:
an AI module, the AI module comprises low-level containers configured to gather, identify extract, translate and transform incoming data;
a redesigner module with high-level containers configured to enrich low-level data from the AI module with knowledge integration from past transactions to deliver an AI output; and
a temperature module with temperature containers for detecting and handling outages and container faults in the AI and redesigner modules.
